(19) United States
(12) Patent Application Publication
(10) Pub. No.: US 2006/0201015 A1
(43) Pub. Date: Sep. 14, 2006

(54) Manual drying device and method therefor

(76) Inventor: Darryl Russell, Las Vegas, NV (US)

Correspondence Address: JASON ROBERTSON, 2812 BURTON AVENUE, LAS VEGAS, NV, 89102, US

(21) Appl. No.: 11/074,858

(22) Filed: Mar. 8, 2005

(51) Int. Cl. F26B 19/00; F26B 25/06

(52) U.S. Cl. 34/90; 34/210

(57) ABSTRACT

Manual drying device and method uses motion applied to a foot pedal to operate an air handler. The air handler propels air toward a user's hands for drying.

### BACKGROUND OF THE INVENTION

1. Field of the Invention

The present invention relates generally to drying devices, and more specifically, to manually powered hand dryers.

2. Background of the Invention

Commonly employed methods of drying hands include using electric hand dryers, cloth towels, paper towels, and wiping wet hands on one's clothing. Although each of these methods is capable of achieving the primary function of drying wet hands, each of these methods also suffers problems that reduce its desirability.

Electric hand dryers typically consist of an air handler mounted on a wall in a restroom. The air handler uses a fan to draw air through inlets and propel the air out toward a user's hands through an outlet. Electric hand dryers often also include a heating element in the path of the blown air to assist in the evaporation of water from the user's hands. However, the fan and heating element are usually powered via a connection to an AC power supply. With the environmental problems associated with the generation and consumption of electrical power, such as pollution, global warming, depletion of natural resources, and nuclear waste, as well as political-economic factors arising from increased dependence on foreign fossil fuel supplies, the use of natural resources to dry hands appears wasteful and irresponsible.

Furthermore, often an electrical power supply is unavailable. For example, public parks or temporary facilities may not have available power to operate an electric fan and heating element. Additionally, power blackouts and brownouts have become increasingly common, making even an available electrical distribution infrastructure not always reliable.

The use of cloth towels to dry hands presents other drawbacks. Labor must be devoted to maintaining a supply of clean towels, removing of soiled towels, and cleaning soiled towels for reuse. Cleaning towels for reuse typically requires the use of toxic or environmentally-damaging cleaning chemicals. Also, electrical washers and dryers are typically used in the cleaning process, again introducing the problems associated with the generation of electrical power using fossil or nuclear fuels. In addition, there is an ever-present possibility that the cleaning process failed to eliminate harmful bacteria or viruses left by a previous user, introducing the risk of infection through the reuse of a cloth towel.

Paper towels, which are typically used once and discarded, also require labor to maintain a supply of new towels and the removal of soiled towels, and introduce other disadvantages related to the use of paper products. These disadvantages include the problems associated with the production of paper, including deforestation with its resulting reduction of oxygen production and carbon monoxide absorption, as well as socio-environmental problems arising from irresponsible logging among indigenous populations and communities. Additionally, the disposal of paper towels contributes to the challenges associated with landfills, including the nationwide dwindling capacity and environmental repercussions.

Although paper towels are available using recycled materials, these products tend to be more expensive, and further require the use of energy and chemicals in the recycling process.

Finally, simply wiping one's hands on clothing creates wet patches on the clothing. Wet clothing is both aesthetically displeasing and uncomfortable. Also, this technique introduces the possibility of transferring harmful germs from clothing onto freshly-cleaned hands.

Therefore, it would be desirable to provide a device and method that provides all of the benefits of present drying devices with none of the drawbacks.

It is an object of the present invention to provide a device and method for drying hands that does not rely on commercial electrical power generation.

It is another object of the present invention to provide a device and method for drying hands without requiring continual maintenance.

It is yet another object of the present invention to provide a device and method for drying hands with less negative environmental impact than prior devices and methods.

### SUMMARY OF THE INVENTION

The above objectives are achieved in a manual drying device and method.

In accordance with one embodiment of the present invention, a manual hand drying device is disclosed. It includes an air handler having an inlet, an outlet, and at least one blowing surface for moving air from the inlet to the outlet. It also includes at least one foot pedal coupled to the air handler so that a motion of the at least one foot pedal operates the air handler, whereby a positioning of the hands of an operator of the device at the outlet during a movement of the at least one foot pedal generates a flow of air onto the hands.

In accordance with another embodiment of the present invention, a method of hand drying is disclosed. It includes the steps of providing at least one air handler for blowing air from an outlet of the air handler, providing at least one foot pedal coupled to the air handler so that a movement of the foot pedal operates the air handler, moving the foot pedal by alternately positioning bodyweight upon the foot pedal and removing bodyweight from the foot pedal, whereby the air handler blows air from the outlet in response to moving the foot pedal, and positioning at least one hand proximate the outlet so that the blown air contacts the hand.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a perspective view of a manual drying device in accordance with an embodiment of the present invention.

FIG. 2 is a perspective view of components of a manual drying device in accordance with an embodiment of the present invention.

FIG. 3 is a block diagram showing components of a manual drying device in accordance with an embodiment of the present invention.

FIG. 4 is a perspective view of components of a manual drying device in accordance with an embodiment of the present invention.

FIG. 5 is a perspective view of components of a manual drying device in accordance with an embodiment of the present invention.

FIG. 6 is a perspective view of components of a manual drying device in accordance with an embodiment of the present invention.

### DETAILED DESCRIPTION OF THE PREFERRED EMBODIMENTS

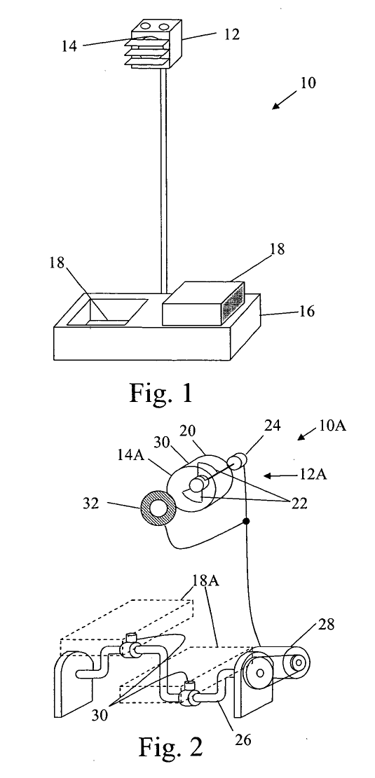

Referring now to the figures and in particular to FIG. 1, a manual hand drying device 10 is shown in accordance with an embodiment of the present invention. An air handler 12 blows air outward from an outlet 14. A base 16 houses two foot pedals 18 that are coupled to air handler 12 so that the motion of pedals 18 operate air handler 18. Pedals 18 are preferably spaced to allow an operator of device 10 to stand with one foot on each pedal 18 and connected so that a downward motion of one pedal 18 results in an upward motion of the other pedal 18 and the operation of air handler 12.

An operator may use device 10 by standing with one foot on each pedal 18 and positioning at least one hand near outlet 14. Positioning bodyweight over one pedal 18 causes the pedal 18 to lower while the other pedal 18 rises, and thus a substantially continual movement of pedals 18 is achievable by engaging in a side-to-side rocking motion. Movement of pedals 18 drives air handler 12, causing an air flow out of outlet 14 onto to operator's hand.

Turning to FIG. 2, components of device 10A are depicted in accordance with an embodiment of the present invention. Air handler 12A blows air using the movement of blowing surfaces 22, depicted as the blades of an electric fan 24. Fan 24 is enclosed by a shroud 30 defining an inlet 20 and outlet 14A.

A shaft 26 is coupled to pedals 18A and shaped so that a downward motion of one pedal 18A causes an upward motion of the other pedal 18A. In the present embodiment, it is preferred that pedals 18A are constrained to substantially vertical motion, and that each pedal 18A is coupled to shaft 26 via a connecting rod 30 pivotally connected to pedal 18A at one end and rotatably connected to shaft 26 at the other end.

Shaft 26 is coupled to a generator 28 via a pulley and belt assembly. Generator 28 is electrically coupled to electric fan 24 and also to a heating element 32. Heating element 32 is positioned within the airflow of air handler 12A to warm the air blown out outlet 14A.

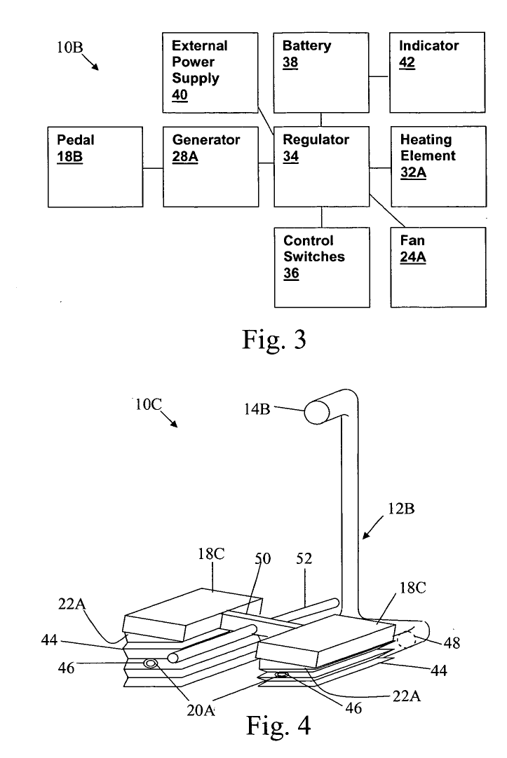

Turning now to FIG. 3, components of manual hand drying device 10B are depicted in a block diagram in accordance with another embodiment of the present invention. Pedal 18B is mechanically coupled to generator 28A so that a motion of pedal 18B results in a generation of electrical power. A regulator 34 transforms the incoming electrical power as needed to drive fan 24A and heating element 32A as selected by control switches 36.

A 200 pound man may expect to generate approximately 100 watts by performing a rocking motion once per second on pedals 18B each traveling 10 cm vertically per stroke. Commercially available electric fans typically operate using a fraction of this; however, heating elements such as for hair dryers and space heaters typically consume 1 kW or more. Although sufficient power may be generated by the operator's motion to warm the air to the operator's satisfaction, it may also be desirable to only operate fan 24A until a sufficient electrical reserve is obtained to operate heating element 32A at a preferred capacity.

A battery 38 is coupled to regulator 34 to store unused electrical energy. When battery 38 is detected to store sufficient energy for a preferred operation of heating element 32A, such as, for example, at 1 kW for 5 seconds, regulator 34 may couple battery 38 to heating element 32A automatically, or in response to the operator's selection via a control switch 36. An indicator 42 provides battery charge information to the operator to assist the decision of using heating element 32A.

For operators that are physically unable to operate pedals 18B or simply choose not to, an external power supply 40 may provide power for fan 24A and heating element 32A. External power supply 40 may be solar, wind-turbine, commercial AC power, or the like. Battery 38 may also store energy provided by external power supply 40, such as if external power supply 40 is a solar panel.

In accordance with another embodiment of the present invention, components of manual hand drying device 10C are depicted in FIG. 4. Air handler 12B includes two pumps 44 coupled to pedals 18C. Each pump 44 defines a chamber, and has a first valve 46 to prevent an egress of air out of pump 44 through inlet 20A and a second valve 48 to prevent an ingress of air into pump 44 through outlet 14B. Blowing surfaces 22A of air handler 12B define the top portion of each pump 44 and are connected to pedals 18C so that a downward motion of pedal 18C compresses the chamber of connected pump 44 and an upward motion of pedal 18C expands the chamber.

A traverse member 50 attaches to one pedal 18C at one end and the other pedal 18C at the other end. A pivoting member 52 is coupled to the center of traverse member 50 and supported by the base (not shown) of device 10C so that a downward motion of one pedal 18C compresses the chamber of one pump 44 and results in an upward motion of the other pedal 18C which expands the chamber of the other pump 44. An operator standing with one foot on each pedal 18C and engaging in a side-to-side rocking motion would thus generate a substantially continuous exhaust of air from outlet 14B.

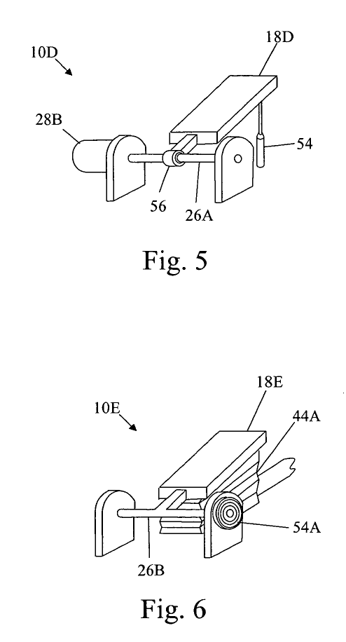

Turning now to FIG. 5, components of a manual hand drying device 10D using a single foot pedal 18D are depicted in accordance with another embodiment of the present invention. Generator 28 converts the rotational motion of shaft 26A to electrical power to operate systems such as depicted in FIGS. 2 and 3. Pedal 18D is coupled to shaft 26A via sprague clutch 56 so that shaft 26A only rotates in response to a downward motion of pedal 18D. A spring 54 biases pedal 18D in an upward position.

An operator may use device 10D by placing his foot on pedal 18D and applying sufficient bodyweight to press pedal 18D down, rotating shaft 26A and operating generator 28B. When sufficient bodyweight is removed from pedal 18D, spring 54 returns pedal 18D to an upward position.

Turning now to FIG. 6, components of a manual hand drying device 10E using a single foot pedal 18E are depicted in accordance with another embodiment of the present invention. Foot pedal 18E is rigidly coupled to shaft 26B. Spring 56A biases pedal 18E in an upward position. Pump 44A is connected to pedal 18E and defines a chamber that expands and compresses in response to movement of pedal 18E. The flow of air into and out of pump 44A is controlled by valves (not shown) to ensure that an operation of pump 44A results in air blown from the outlet (not shown) of device 10E for drying an operator's hands.

An operator may use device 10E by placing his foot on pedal 18E and applying sufficient bodyweight to press pedal 18E down, compressing pump 44A and causing the exhaust of air from pump 44A. When sufficient bodyweight is removed from pedal 18E, spring 54A returns pedal 18D to an upward position.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A manual hand drying device, comprising in combination:
an air handler having an inlet, an outlet, and at least one blowing surface for moving air from said inlet to said outlet; and
at least one foot pedal coupled to said air handler so that a motion of said at least one foot pedal operates said air handler, whereby a positioning of the hands of an operator of said device at said outlet during a movement of said at least one foot pedal generates a flow of air onto said hands.

2. The device of claim 1, wherein said at least one blowing surface of said air handler comprises the blades of a fan.

3. The device of claim 2, wherein said fan is electric, and further comprising:
a shaft coupled to at least one said foot pedal so that a motion of said foot pedal rotates said shaft; and
a generator mechanically coupled to said shaft and electrically coupled to said fan, whereby a rotation of said shaft generates electricity for operating said fan.

4. The device of claim 3, further comprising two foot pedals coupled to said shaft so that a rotation of said shaft resulting from a downward motion of one said foot pedal generates an upward motion of the other said foot pedal, whereby said shaft is continually rotatable by an operator standing with one foot on each said foot pedal and engaging in a rocking motion.

5. The device of claim 3, further comprising a spring coupled to said at least one foot pedal for biasing said foot pedal in an upward position, wherein said foot pedal is coupled to said shaft via a clutch so that only a downward motion of said foot pedal rotates said shaft, whereby said shaft is rotatable by a periodic positioning of an operator's weight onto said foot pedal.

6. The device of claim 1, wherein said air handler further comprises a pump defining a chamber, a first valve to prevent an egress of air out of said pump through said inlet and a second valve to prevent an ingress of air into said pump through said outlet, and wherein said blowing surface defines a portion of said pump so that a downward motion of said foot pedal compresses said chamber and an upward motion of said foot pedal expands said chamber.

7. The device of claim 6, further comprising a spring coupled to said at least one foot pedal for biasing said at least one foot pedal in an upward position.

8. The device of claim 6, further comprising:
two said foot pedals,
a traverse member coupled to one said foot pedal at one end and the other said foot pedal at the other end;
a pivoting member coupled to the center of said traverse member so that a downward motion of one said foot pedal results in an upward motion of the other said foot pedal; and
two said pumps coupled to said foot pedals so that a downward motion of one said foot pedal compresses the chamber of one said pump and expands the chamber of the other said pump.

9. The device of claim 1, further comprising:
a heating element for heating said air blown by said air handler;
a shaft coupled to at least one said foot pedal so that a motion of said foot pedal rotates said shaft; and
a generator mechanically coupled to said shaft and electrically coupled to said heating element, whereby a rotation of said shaft generates electrical energy for operating said heating element.

10. The device of claim 9, further comprising a battery coupled to said generator for storing an output of said generator.

11. The device of claim 10, further comprising an indicator for displaying a charge of said battery.

12. The device of claim 1, further comprising:
a heating element for heating said air blown by said air handler;
an external power supply; and
a switch for selectively coupling said heating element to said external power supply, whereby an operation of said heating device is controlled by said switch.

13. A method of hand drying, comprising the steps of:
providing at least one air handler for blowing air from an outlet of said air handler;
providing at least one foot pedal coupled to said air handler so that a movement of said foot pedal operates said air handler;
moving said foot pedal by alternately positioning bodyweight upon said foot pedal and removing bodyweight from said foot pedal, whereby said air handler blows air from said outlet in response to said moving said foot pedal; and
positioning at least one hand proximate said outlet so that said blown air contacts said at least one hand.

14. The method of claim 13, wherein said step of providing at least one foot pedal comprises the steps of:
providing a first foot pedal;
providing a second foot pedal coupled to said first foot pedal so that an upward motion of one said foot pedal results from a downward motion of the other said foot pedal; and
coupling at least one of said first foot pedal and said second foot pedal to said air handler so that a movement of at least one of said first foot pedal and said second foot pedal operates said air handler.

15. The method of claim 13, wherein said step of moving said foot pedal is performed by standing with one foot on one said foot pedal and the other foot on the other said foot pedal and shifting said bodyweight from one said foot to the other said foot.

16. The method of claim 13, further comprising the step of providing a heating element positioned in the path of said air that is blown for heating said air that is blown.

17. The method of claim 16, further comprising the step of providing a generator mechanically coupled to at least one said foot pedal and electrically coupled to said heating element, whereby said moving said foot pedal generates electrical energy for operating said heating element.

18. The method of claim 17, further comprising the steps of:
providing a battery coupled to said generator; and
storing an output of said generator with said battery.

19. The method of claim 18, further comprising the steps of:
detecting a sufficient charge of said battery for an operation of said heating element; and
electrically coupling said heating element to said battery for operating said heating element with said battery.
